(19) United States
(12) Patent Application Publication
(10) Pub. No.: US 2026/0058058 A1
(43) Pub. Date: Feb. 26, 2026

(54) MULTILAYER CERAMIC CAPACITOR

(71) Applicant: Murata Manufacturing Co., Ltd., Nagaokakyo-shi, (JP)

(72) Inventor: Hayato FUKUSHIMA, Nagaokakyo-shi (JP)

(21) Appl. No.: 19/374,407

(22) Filed: Oct. 30, 2025

Related U.S. Application Data
(63) Continuation of application No. PCT/JP2024/014543, filed on Apr. 10, 2024.

(30) Foreign Application Priority Data
May 31, 2023 (JP) 2023-089938

(51) Int. Cl. H01G 4/008; H01G 4/012; H01G 4/30

(52) U.S. Cl. CPC H01G 4/008; H01G 4/012; H01G 4/30

(57) ABSTRACT

A multilayer ceramic capacitor includes a multilayer body including an inner layer portion in which a plurality of dielectric layers and a plurality of internal electrode layers are laminated, and outer layer portions sandwiching the inner layer portion in a lamination direction, and external electrodes provided on a surface of the multilayer body and electrically connected to the plurality of internal electrode layers. A dummy electrode layer that does not contribute to generation of capacitance is provided in a region of at least one of the outer layer portions opposed to the plurality of internal electrode layers.

### CROSS REFERENCE TO RELATED APPLICATIONS

This application claims the benefit of priority to Japanese Patent Application No. 2023-089938 filed on May 31, 2023 and is a Continuation Application of PCT Application No. PCT/JP2024/014543 filed on Apr. 10, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In the prior art, in the manufacture of multilayer ceramic capacitors each including a multilayer body having an inner layer portion including a plurality of dielectric layers and a plurality of internal electrode layers that are laminated, and external electrodes electrically connected to the plurality of internal electrode layers on surfaces of the multilayer body, first, a green sheet functioning as a dielectric layer on a surface of which an electrode pattern functioning as an internal electrode layer is printed is prepared, and a plurality of layers are laminated and pressed while adjusting a position of the green sheet to form an inner layer portion, further, a plurality of green sheets on each of which an internal electrode pattern functioning as an outer layer portion is not printed are laminated on both sides of the inner layer portion, such that the layered configuration of the multilayer body is provided.

However, since a step difference is present on the surface of each of the green sheets by the amount of the printed electrode pattern, when the laminated green sheets are pressed from the lamination direction, the end portion of the electrode pattern functioning as the step difference portion extends on the surface of the dielectric layer perpendicularly to the lamination direction.

The stress due to such pressing is likely to be applied to the end portion (the portion R shown in FIG. 5) of the internal electrode layer provided as the uppermost layer or the lowermost layer in the laminated body, and the end portion of the internal electrode layer is likely to be excessively stretched, such that rupture of the internal electrode layer and structural defects in the dielectric layer are likely to occur.

In addition, in the multilayer ceramic capacitor, in order to improve the electrical characteristics, the internal electrode layers each include a predetermined metal component, but when the multilayer body is fired, in the internal electrode layer provided as the uppermost layer or the lowermost layer, outflow of the metal component to the outer layer portion easily occurs, which tends to lead to a decrease in the reliability of the multilayer ceramic capacitor due to a change in the electrical characteristics.

Therefore, there is a demand to develop multilayer ceramic capacitors each having excellent electrical characteristics while stably maintaining the shapes and components of the internal electrode layers.

### SUMMARY OF THE INVENTION

Example embodiments of the present invention provide multilayer ceramic capacitors each having excellent electrical characteristics while stably maintaining the shapes and components of internal electrode layers.

The present inventor has discovered that, in a multilayer ceramic capacitor including a multilayer body including an inner layer portion in which a plurality of dielectric layers and a plurality of internal electrode layers are laminated and outer layer portions sandwiching the inner layer portion in a lamination direction, and external electrodes located on a surface of the multilayer body and electrically connected to the plurality of internal electrode layers, when a plurality of dummy electrode layers that do not contribute to generation of capacitance are provided in a region of at least one of the outer layer portions opposed to the internal electrode layers, the shape and components of the internal electrode layers are stably maintained.

An example embodiment of the present invention provides a multilayer ceramic capacitor that includes a multilayer body including an inner layer portion in which a plurality of dielectric layers and a plurality of internal electrode layers are laminated, and outer layer portions sandwiching the inner layer portion in a lamination direction, and external electrodes located on a surface of the multilayer body and electrically connected to the plurality of internal electrode layers, in which a dummy electrode layer that does not contribute to generation of capacitance is provided in a region of at least one of the outer layer portions opposed to the plurality of internal electrode layers.

According to example embodiments of the present invention, it is possible to provide multilayer ceramic capacitors each having excellent electrical characteristics while stably maintaining the shapes and components of the internal electrode layers.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor according to an example embodiment of the present invention.

FIG. 2 is a cross-sectional view of a multilayer ceramic capacitor according to an example embodiment of the present invention taken along the line A-A.

FIG. 3 is a cross-sectional view of a multilayer ceramic capacitor according to an example embodiment of the present invention taken along the line B-B.

FIG. 4 is an exploded perspective view showing a laminated state of dielectric layers and internal electrode layers in a multilayer ceramic capacitor according to an example embodiment of the present invention.

FIG. 5 is a cross-sectional view of a conventional multilayer ceramic capacitor taken along the line A-A.

FIG. 6 is an exploded perspective view showing a laminated state of dielectric layers and internal electrode layers in a multilayer body of a conventional multilayer ceramic capacitor.

FIGS. 7A to 7D are diagrams showing a method of manufacturing a multilayer ceramic capacitor according to an example embodiment of the present invention.

### DETAILED DESCRIPTION OF THE EXAMPLE EMBODIMENTS

Hereinafter, multilayer ceramic capacitors will be described according to example embodiments of the present invention, but the present invention is not to be limited thereto. In addition, the drawings may be schematically simplified and drawn in order to explain the contents of example embodiments of the invention, and the drawn components or the ratio of the dimensions between the components may not coincide with the ratio of the dimensions described in the specification. In addition, components described in the specification may be omitted in the drawings or may be drawn with the number of components omitted.

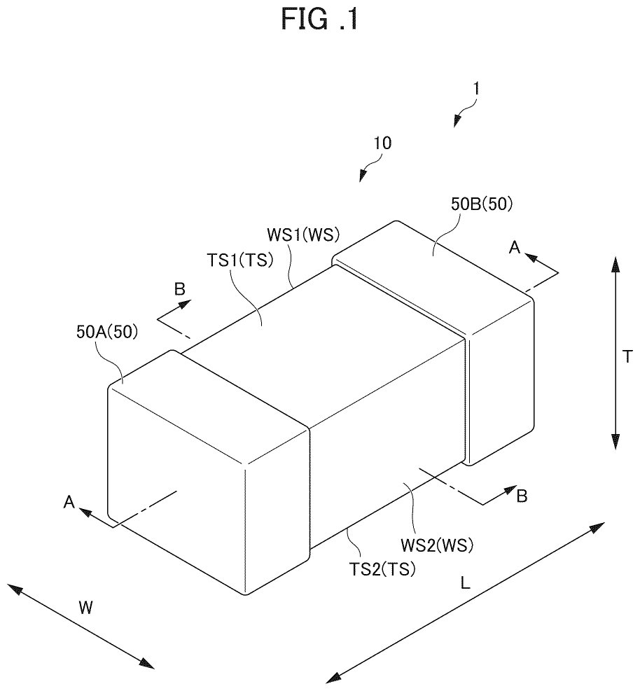

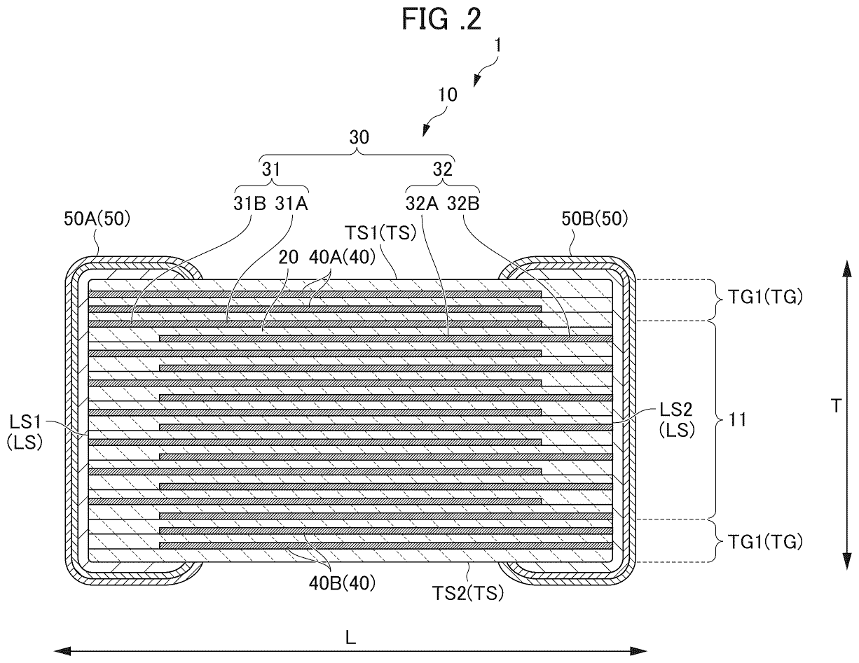

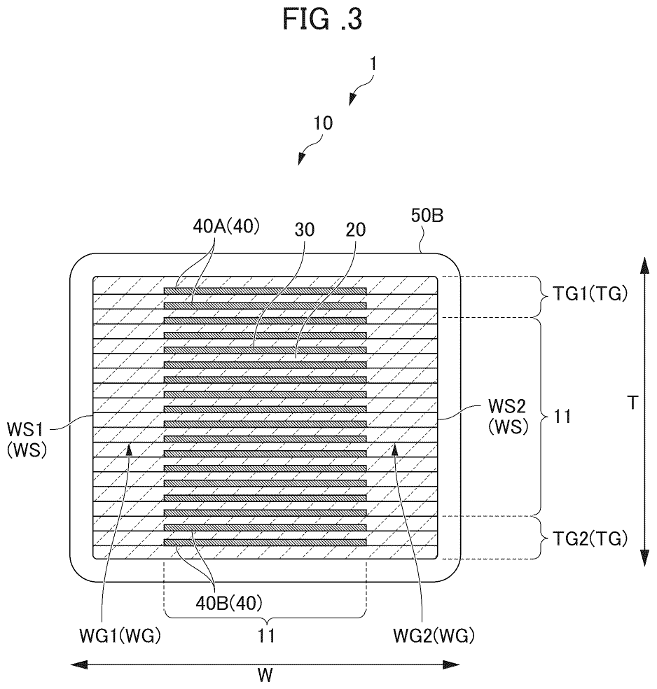

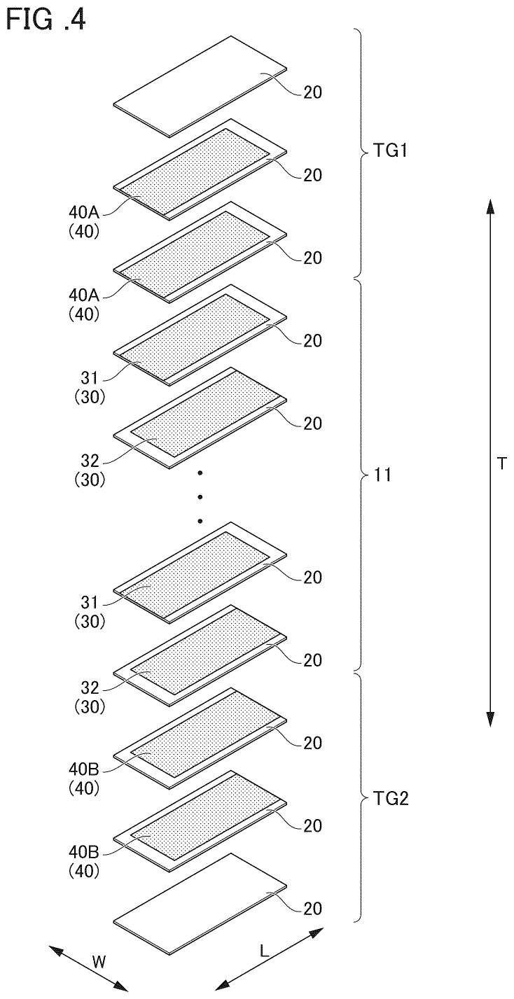

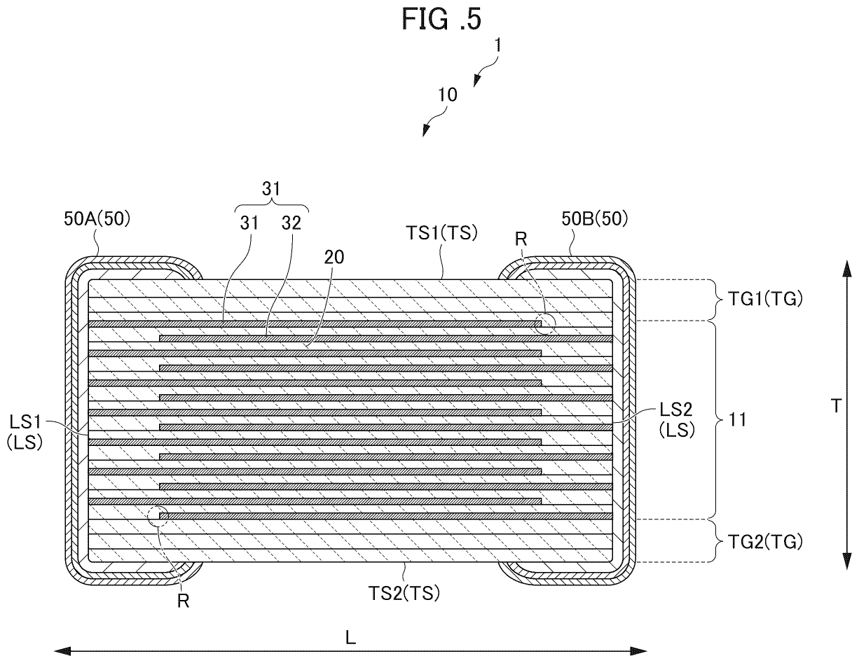

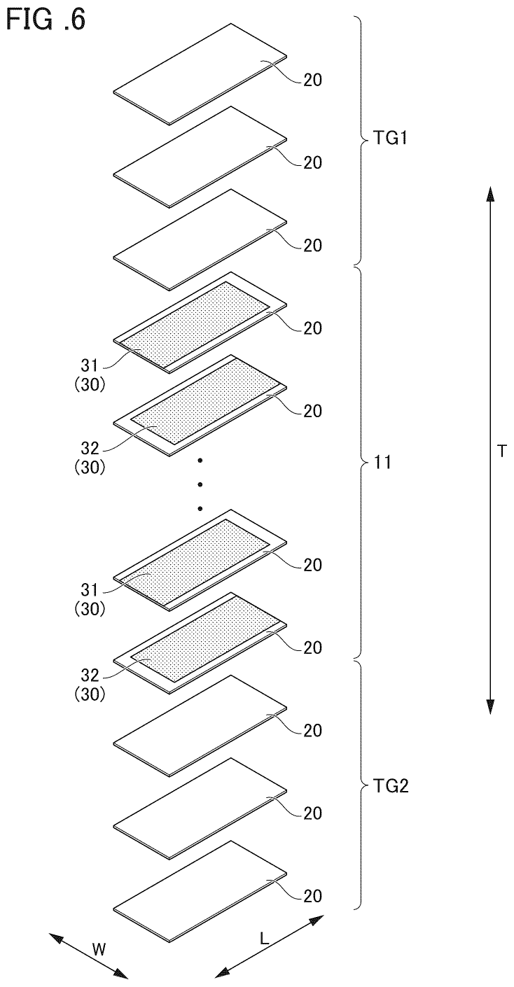

FIG. 1 is a schematic perspective view of a multilayer ceramic capacitor. FIG. 2 is a cross-sectional view of a multilayer ceramic capacitor according to an example embodiment of the present invention taken along the line A-A shown in FIG. 1. FIG. 3 is a cross-sectional view of a multilayer ceramic capacitor according to an example embodiment of the present invention taken along the line B-B shown in FIG. 1. FIG. 4 is an exploded perspective view showing a laminated state of dielectric layers and internal electrode layers in a multilayer ceramic capacitor according to an example embodiment of the present invention. FIG. 5 is a cross-sectional view of a conventional multilayer ceramic capacitor taken along the line A-A shown in FIG. 1. FIG. 6 is an exploded perspective view showing a laminated state of dielectric layers and internal electrode layers in a multilayer body of a conventional multilayer ceramic capacitor. The line A-A shown in FIG. 1 passes through a middle portion of the multilayer ceramic capacitor in a width direction W described later. The line B-B shown in FIG. 1 passes through a middle portion of the multilayer ceramic capacitor in a length direction L described later. The cross section shown in FIGS. 2 and 5 may be referred to as an LT cross section, and the cross section shown in FIG. 3 may be referred to as a WT cross section.

The multilayer ceramic capacitor 1 has a substantially rectangular parallelepiped shape and includes a multilayer body 10 and a pair of external electrodes 50 provided at both ends of the multilayer body 10. The multilayer body 10 includes an inner layer portion 11 in which a plurality of dielectric layers 20 and a plurality of internal electrode layers 30 are laminated.

In the following description, as terms indicating the orientation of the multilayer ceramic capacitor 1, a direction in which the pair of external electrodes 50 are provided is referred to as a length direction L. A direction in which the dielectric layers 20 and the internal electrode layers 30 are laminated is referred to as a lamination direction T. A direction intersecting both the length direction L and the lamination direction T is defined as a width direction W. In the example embodiments, the length direction L, the lamination direction T, and the width direction W are orthogonal to each other.

The multilayer body 10 has a substantially rectangular parallelepiped shape. The corner portions and ridge portions of the multilayer body 10 are preferably rounded. Each of the corner portions is a portion where three surfaces of the multilayer body 10 intersect, and each of the ridge portions is a portion where two surfaces of the multilayer body 10 intersect. The dimension of the multilayer body 10 in the length direction L is not necessarily longer than the dimension in the width direction W. In addition, unevenness or the like may be formed on a portion or the entirety of the surface of the multilayer body 10.

The dimension of the multilayer body 10 is not particularly limited, but when the dimension in the length direction L of the multilayer body 10 is defined as an L dimension, the L dimension is preferably about 0.39 mm or more and about 3.30 mm or less, for example. When the dimension in the lamination direction T of the multilayer body 10 is defined as a T dimension, the T dimension is preferably not less than about 0.21 mm and not more than about 2.70 mm, for example. When the dimension in the width direction W of the multilayer body 10 is defined as a W dimension, the W dimension is preferably about 0.21 mm or more and about 2.70 mm or less, for example.

As shown in FIGS. 1 to 3, the multilayer body 10 includes a first main surface TS1 and a second main surface TS2 that are opposed to each other in the lamination direction T, a first lateral surface WS1 and a second lateral surface WS2 that are opposed to each other in the width direction W that intersects the lamination direction T, and a first end surface LS1 and a second end surface LS2 that are opposed to each other in the length direction L that intersects the lamination direction T and the width direction W.

The multilayer body 10 includes an inner layer portion 11 in which the internal electrode layers 30 and the dielectric layers 20 are laminated, side margin portions WG provided on both sides of the inner layer portion 11 in the width direction W, and outer layer portions TG provided on both sides of the inner layer portion 11 in the lamination direction T.

The inner layer portion 11 is a region where the internal electrode layers 30 and the dielectric layers 20 are laminated in the multilayer body 10. When a first counter portion 31A of each of the first internal electrode layers 31 and a second counter portion 32A of each of the second internal electrode layers 32 are opposed to each other with a corresponding one of the dielectric layers 20 interposed therebetween, capacitance is generated. The inner layer portion 11 includes from the internal electrode layer 30 located closest to the first main surface TS1 to the internal electrode layer 30 located closest to the second main surface TS2 in the lamination direction T.

The plurality of dielectric layers 20 laminated in the multilayer body 10 can be made of a ceramic material. As the ceramic material, for example, a dielectric ceramic including BaTiO₃ as a main component is used. Further, as the ceramic material, a material obtained by adding at least one subcomponent such as a Mn compound, a Fe compound, a Cr compound, a Co compound, or a Ni compound to these main components may be used.

The thickness of each of the dielectric layers 20 is preferably about 0.3 μm or more and about 1.1 μm or less, and particularly preferably about 0.45 μm or more and about 0.55 μm or less, for example. The number of laminated dielectric layers 20 is preferably ten or more and 700 or less, for example. The number of the dielectric layers 20 is the total number of the number of the dielectric layers of the inner layer portion 11 and the number of the dielectric layers of the outer layer portion TG including the first outer layer portion TG1 and the second outer layer portion TG2.

The plurality of internal electrode layers 30 laminated in the multilayer body 10 include a plurality of first internal electrode layers 31 and a plurality of second internal electrode layers 32. The plurality of first internal electrode layers 31 are each provided on a corresponding one of the plurality of dielectric layers 20. The plurality of second internal electrode layers 32 are each provided on a corresponding one of the plurality of dielectric layers 20. The plurality of first internal electrode layers 31 and the plurality of second internal electrode layers 32 are alternately provided in the lamination direction T of the multilayer body 10.

Each of the first internal electrode layers 31 includes a first counter portion 31A opposed to the second internal electrode layer 32, and a first extension portion 31B extending from the first counter portion 31A toward the first end surface LS1. The first extension portion 31B is exposed at the first end surface LS1.

Each of the second internal electrode layers 32 includes a second counter portion 32A opposed to the first internal electrode layer 31, and a second extension portion 32B extending from the second counter portion 32A toward the second end surface LS2. The second extension portion 32B is exposed at the second end surface LS2.

Each of the internal electrode layers 30 includes, for example, a metal such as Ni, Cu, Ag, Pd, or Au, or an appropriate electrically conductive material such as an alloy including at least one of these metals. When an alloy is used, the internal electrode layer 30 may include, for example, an Ag—Pd alloy or the like. The internal electrode layer 30 may include dielectric particles with the same composition as the ceramics included in the dielectric layer 20.

The material of the internal electrode layer 30 preferably includes Ni and Sn. Further, Ni and Sn may include alloyed portions. By alloying Ni and Sn, the state of the internal electrode layer 30 in the vicinity of the interface with the dielectric layer 20 (electrical barrier height) changes, which contributes to the improvement of the high-temperature load life. As a result, the multilayer ceramic capacitor 1 excellent in reliability (improvement of high-temperature load life) at the time of voltage application can be obtained. In addition, the Sn may be a Sn material made of any of a metal including Sn and a Sn compound, or a tin oxide powder represented by SnO or SnO₂ instead of Sn.

By adding Sn to Ni as a main component, an alloy including Sn is made in the internal electrode layer 30, and an interfacial layer including Sn is made at the interface between the internal electrode layer 30 and the dielectric layer 20. By providing such an interfacial layer, the high-temperature load life of the multilayer ceramic capacitor 1 is improved, and the reliability thereof is improved.

In a case where Ni is used as a main component and Sn is added thereto, the content of Sn when the total of Ni and Sn is about 100 mol is preferably about 0.1 mol or more and about 10 mol or less, for example. When Sn is less than about 0.1 mol, the advantageous effect of adding Sn is hardly exhibited. On the other hand, when Sn exceeds about 10 mol, the interfacial layer is made excessively thick, and the capacitance of the multilayer ceramic capacitor 1 decreases. The above state can be achieved by adding Sn as a subcomponent to Ni as a main component in the electrically conductive paste for forming the internal electrode layer or by adding a Ni—Sn alloy to the electrically conductive paste for forming the internal electrode.

A method for incorporating Sn is not particularly limited. For example, Sn may be included in advance in the electrically conductive paste to be the internal electrode layer 30, or may be mixed with the raw material powder of the dielectric ceramic of the dielectric layer 20 after firing. In the latter case, when the Sno powder is mixed with the raw material powder of the dielectric ceramic, and then fired at a temperature rising rate of about 20° C./min or more in a reducing atmosphere, for example, the Sno is reduced to Sn and is easily absorbed by the internal electrode layer 30.

The Sn included in the internal electrode layer 30 is likely to migrate to the outer layer portion TG when the multilayer body 10 is fired, and the advantageous effect expected by the alloy layer made of Ni and Sn may not be sufficiently exhibited in some cases; however, since the migration of Sn from the internal electrode layer 30 to the outer layer portion TG can be reduced or prevented by providing a dummy electrode layer 40 described later, it is possible to improve the functionality of the internal electrode layer 30 in the inner layer portion 11.

As a method of confirming the alloy layer, the multilayer body 10 is cross-sectionally polished (for example, the LT cross-section is exposed at the middle portion in the width direction W), and the difference in composition is confirmed by WDX analysis, and the range of the alloy layer can be specified from the difference in composition. Further, by thinning a portion of the cross section (including the dielectric layer 20 and the internal electrode layer 30) and performing TEM analysis, it is possible to confirm the difference in composition in more detail.

The thickness of each of the internal electrode layers 30 is preferably about 0.25 μm or more and about 0.6 μm or less, and particularly preferably about 0.4 μm or more and about 0.5 μm or less, for example. The number of the internal electrode layers 30 is preferably five or more and 350 or less, for example.

The side margin portions WG are regions provided on both sides of the inner layer portion 11 in the width direction W, and include a first side margin portion WG1 that provides the first lateral surface WS1 of the multilayer ceramic capacitor 1, and a second side margin portion WG2 that provides the second lateral surface WS2 of the multilayer ceramic capacitor 1. The side margin portions WG can be made of the same material as the dielectric layer 20.

The outer layer portions TG are regions provided on both sides of the inner layer portion 11 in the lamination direction T, and include a first outer layer portion TG1 that provides the first main surface TS1 of the multilayer ceramic capacitor 1, and a second outer layer portion TG2 that provides the second main surface TS2 of the multilayer ceramic capacitor 1.

The outer layer portions TG can be made of the same material as the dielectric layer 20 of the inner layer portion 11. The outer layer portion TG can be made by laminating a plurality of dielectric layers 20.

Dummy electrode layers 40 are provided in the regions of the outer layer portions TG opposed to the internal electrode layer 30. Since the dummy electrode layers 40 do not generate capacitance, they are connected to the same external electrode 50 as the opposed internal electrode layer 30 are connected to, or are not connected to the external electrode 50.

A plurality of dummy electrode layers 40 may be provided in the lamination direction T with a corresponding one of the dielectric layers 20 interposed therebetween. The outer layer portions TG can be each made by laminating a plurality of dielectric layers 20 in the lamination direction T. However, by providing the dummy electrode layers 40 with a corresponding one of the dielectric layers 20 interposed therebetween, a layered structure of the dielectric layers 20 and the dummy electrode layers 40 is provided, such that the plurality of dummy electrode layers 40 can be provided in each of the outer layer portions TG.

The dummy electrode layers 40 can each be made of, for example, a metal such as Ni, Cu, Ag, Pd, or Au, or an appropriate electrically conductive material such as an alloy including at least one of these metals. When an alloy is used, the dummy electrode layers 40 may be made of, for example, an Ag—Pd alloy. The dummy electrode layers 40 can be made of the same material as the internal electrode layer 30.

The material of the dummy electrode layers 40 preferably includes Ni and Sn. Further, Ni and Sn may include alloyed portions. This makes it possible to effectively reduce or prevent Sn from migrating from the internal electrode layers 30 to the outer layer portions TG. In addition, a Sn material made of either a metal including Sn or a Sn compound may be used, and a tin oxide powder represented by SnO or SnO₂ may be used instead of Sn.

By adding Sn to the main component Ni forming the dummy electrode layers 40, the sintering temperature of the dummy electrode layers 40 is lowered. With such a configuration, when the multilayer body 10 is fired, the degree of shrinkage of the dummy electrode layers 40 becomes larger than that of the outer layer portions TG. For this reason, in the multilayer body 10 after firing, a compressive stress is generated in the outer layer portions TG, an advantageous effect of reducing or preventing the extension of cracks generated by a tensile stress received from the outside at the time of using the multilayer ceramic capacitor is achieved, and as a result, it is possible to improve the mechanical strength of the multilayer ceramic capacitor 1.

In a case where Ni is used as a main component and Sn is added thereto, the content of Sn when the total of Ni and Sn is about 100 mol is preferably about 0.1 mol or more and about 10 mol or less, for example. When Sn is less than about 0.1 mol, the advantageous effect of adding Sn is hardly exhibited. On the other hand, when Sn exceeds about 10 mol, shrinkage of the dummy electrode layers 40 becomes too large at the time of firing the multilayer body 10, and tensile stress is generated in the dummy electrode layers 40 after firing, and cracks are likely to occur. When a crack extends to the internal electrode layers 30 located in the upper layer portion or the lower layer portion of the inner layer portion 11, the high-temperature reliability of the multilayer ceramic capacitor 1 is impaired. The above state can be achieved by adding Sn as a subcomponent to Ni as a main component in the electrically conductive paste for forming the dummy electrode layers or by adding a Ni—Sn alloy to the electrically conductive paste for forming the internal electrodes.

The method of incorporating Sn is not particularly limited. For example, Sn may be included in advance in the electrically conductive paste to be the dummy electrode layers 40, or may be mixed with the raw material powder of the dielectric ceramic of the dielectric layers 20 after firing. In the latter case, when the Sno powder is mixed with the raw material powder of the dielectric ceramic, and then fired at a temperature rising rate of about 20° C./min or more in a reducing atmosphere, for example, the Sno is reduced to Sn and is easily absorbed by the dummy electrode layers 40.

The portion where Ni and Sn are alloyed preferably has an alloy layer so as to cover the internal electrode layers 30 at the interface between the dielectric layers 20 and the dummy electrode layers 40.

As a method of confirming the alloy layer, the multilayer body 10 is cross-sectionally polished (for example, the LT cross-section is exposed at the middle portion in the width direction W), and the difference in composition is confirmed by WDX analysis, and the range of the alloy layer can be specified from the difference in composition. Further, by thinning a portion of the cross section (including the dielectric layers 20 and the internal electrode layers 30) and performing TEM analysis, it is possible to confirm the difference in composition in more detail.

The thickness of each of the dummy electrode layers 40 is preferably about 0.25 μm or more and about 0.6 μm or less, and particularly preferably about 0.4 μm or more and about 0.5 μm or less, for example.

In the example embodiment shown in FIG. 2, in the first outer layer portion TG1, first dummy electrode layers 40A are provided so as to be opposed to a first internal electrode layer 31 provided as the uppermost layer of the internal electrode layers 30 laminated in the inner layer portion 11. The first dummy electrode layers 40A are exposed at the first end surface LS1 of the multilayer body 10 in the same manner as the first internal electrode layer 31 provided as the uppermost layer. Although FIG. 2 shows a configuration in which two layers of the first dummy electrode layers 40A are provided, the number of the first dummy electrode layers 40A provided is not limited to two, and may be one or three or more.

In the example embodiment shown in FIG. 2, in the second outer layer portion TG2, second dummy electrode layers 40B are provided so as to be opposed to a second internal electrode layer 32 provided as the lowermost layer of the internal electrode layers 30 laminated in the inner layer portion 11. The second dummy electrode layers 40B are exposed at the second end surface LS2 of the multilayer body 10 in the same manner as the second internal electrode layer 32 provided as the lowermost layer. FIG. 2 shows a configuration in which two layers of the second dummy electrode layers 40B are provided, but the number of the provided second dummy electrode layers 40B is not limited to two, and may be one or three or more layers.

FIG. 5 is an LT cross-sectional view of a conventional multilayer ceramic capacitor 1 taken along the line A-A. The outer layer portion TG is made by laminating a plurality of dielectric layers 20. FIG. 6 is an exploded perspective view showing the laminated state of the dielectric layers 20 and the internal electrode layers 30 in the multilayer body 10 of the conventional multilayer ceramic capacitor 1.

In the prior art, in the manufacture of the multilayer ceramic capacitor 1, a green sheet functioning as the dielectric layer 20 on the surface of which an electrode pattern functioning as the internal electrode layer 30 is printed is prepared, a plurality of green sheets are laminated and pressed while adjusting the position of the green sheet to form the inner layer portion 11, and a plurality of green sheets on which an internal electrode layer pattern functioning as the outer layer portion TG is not printed are laminated on both sides of the green sheet to form the layered configuration of the multilayer body 10. Since the surface of the green sheet has a step difference corresponding to the amount of the printed electrode pattern, when the laminated green sheet is pressed from the lamination direction, an end portion of the electrode pattern, which is an edge portion of the step difference, extends on the surface of the dielectric layer perpendicularly to the lamination direction. In particular, such a stress due to pressing is likely to be applied to the end portion (the portion R shown in FIG. 5) of the internal electrode layer 30 provided as the uppermost layer or the lowermost layer in the multilayer body, and the end portion (the portion R shown in FIG. 5) of the internal electrode layer 30 provided as the uppermost layer or the lowermost layer in the multilayer body is excessively stretched, such that tearing of the internal electrode layer 30 and structural defects in the dielectric layer 20 are likely to occur.

In a multilayer ceramic capacitor 1 according to an example embodiment of the present invention, the dummy electrode layers 40 are provided between the dielectric layers of the outer layer portions TG in a shape corresponding to the opposed region of the internal electrode layers 30.

For this reason, in the manufacturing process of the multilayer body 10, even when the green sheet is pressed in the lamination direction T, the stress is absorbed by the outer layer portions TG or the dummy electrode layers 40 in the outer layer portions TG, and in the inner layer portion 11 which generates the actual capacitance, a partial crack or partial peeling does not occur, and thus, short circuit does not occur between the internal electrode layers, and the stable insulation reliability can be maintained.

That is, multilayer ceramic capacitors each having a high capacitance are obtained without generating an internal defect in the capacitance generation portion.

The external electrodes 50 include a first external electrode 50A provided on the first end surface LS1 and a second external electrode 50B provided on the second end surface LS2. The external electrodes 50 each cover not only the end surface LS, but also a portion of the main surface TS and a portion of the lateral surface WS which are continuous with the end surface LS.

An end portion of the first extension portion 31B of each of the first internal electrode layers 31 is exposed at the first end surface LS1 and is electrically connected to the first external electrode 50A. In addition, an end portion of the second extension portion 32B of each of the second internal electrode layers 32 is exposed at the second end surface LS2, and is electrically connected to the second external electrode 50B. Thus, a plurality of capacitor elements are electrically connected in parallel between the first external electrode 50A and the second external electrode 50B.

Since the first dummy electrode layers 40A are exposed at the first end surface LS1 of the multilayer body 10 and are connected to the first external electrode 50A in the same manner as the first internal electrode layer 31 provided as the uppermost layer, the first dummy electrode layers 40A do not contribute to the formation of capacitance. It can be configured so that the first dummy electrode layers 40A are not connected to either the first external electrode 50A or the second external electrode 50B, and not electrically connected to the external electrodes 50.

Since the second dummy electrode layers 40B are exposed at the second end surface LS2 of the multilayer body 10 and are connected to the second external electrode 50B in the same manner as the second internal electrode layer 32 provided as the lowermost layer, the second dummy electrode layers 40B do not contribute to the formation of capacitance. It can be configured so that the second dummy electrode layer 40B is not connected to either the second external electrode 50B or the first external electrode 50A, and not electrically connected to the external electrodes 50.

The external electrodes 50 each include, for example, a base electrode layer and a plated layer. Each of the external electrodes 50 do not necessarily have such a layer configuration.

The base electrode layer is made by, for example, applying and firing an electrically conductive paste including Cu. The base electrode layer may include glass.

The plated layer includes a Ni plated layer provided on the surface of the base electrode layer and a Sn plated layer provided on the surface of the Ni plated layer. The configuration of the plated layer is not limited thereto.

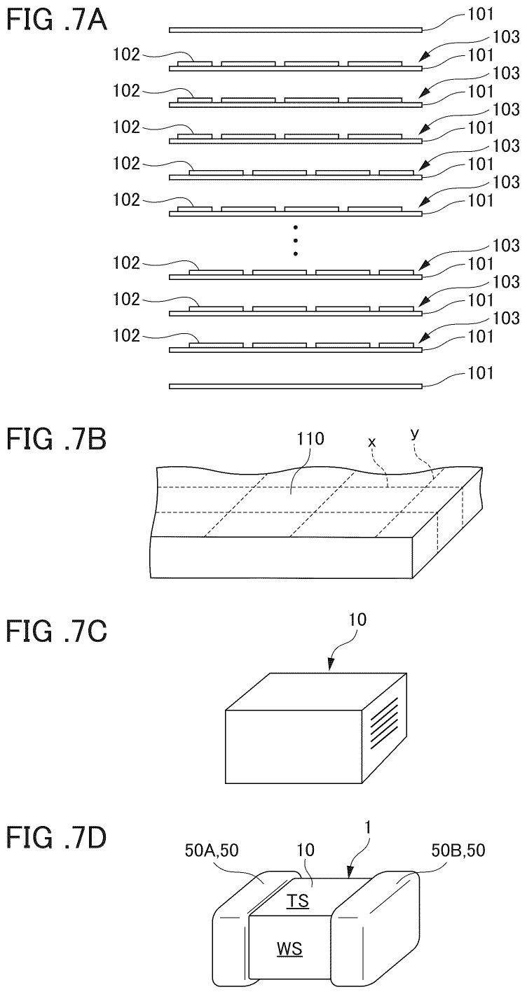

A non-limiting example of a method of manufacturing the multilayer ceramic capacitor 1 will be described with reference to FIG. 7.

The ceramic slurry including the ceramic powder, the binder, and the solvent is molded into a sheet shape on the surface of the carrier film by using a die coater, a gravure coater, a microgravure coater, or the like to produce the ceramic green sheet for lamination 101 functioning as the dielectric layer 20. Next, an electrically conductive paste is printed on the ceramic green sheet for lamination 101 in a band shape by screen printing, inkjet printing, gravure printing, or the like, and an electrically conductive pattern 102 functioning as the internal electrode layer 30 is printed on the surface of the ceramic green sheet for lamination 101 to form a material sheet 103.

Subsequently, as shown in FIG. 7A, a plurality of material sheets 103 are laminated so that the electrically conductive patterns 102 face the same direction and the electrically conductive patterns 102 are shifted by a half pitch in the length direction between the adjacent material sheets 103. This portion forms the inner layer portion 11 of the multilayer body 10.

Then, the material sheet 103 is provided on the uppermost layer of the plurality of material sheets 103 laminated in a state of being shifted by a half pitch so that the electrically conductive pattern 102 overlaps with the material sheet 103 of the uppermost layer as viewed in the lamination direction T, and the ceramic green sheet for lamination 101 on which the electrically conductive pattern 102 is not printed is provided thereon. This portion forms the first outer layer portion TG1 including the first dummy electrode layers 40A. FIG. 7A shows a configuration in which two layers of the material sheets 103 forming the first dummy electrode layers 40A are provided and one layer of the ceramic green sheet for lamination 101 on which the electrically conductive pattern 102 is not printed is provided, but the number of the first dummy electrode layers 40A to be provided are not limited to two, and may be one or three or more. In addition, the number of the ceramic green sheets for lamination 101 on which the electrically conductive pattern 102 is not printed is not limited to one, and may be plural.

Similarly, the material sheet 103 is provided below the lowermost layer of the plurality of material sheets 103 laminated in a state of being shifted by a half pitch so that the electrically conductive pattern 102 overlaps with the material sheet 103 of the lowermost layer as viewed in the lamination direction T, and the ceramic green sheet for lamination 101 on which the electrically conductive pattern 102 is not printed is provided below the material sheet. This portion forms the second outer layer portion TG2 including the second dummy electrode layers 40B. FIG. 7A shows a configuration in which two layers of the material sheets 103 forming the second dummy electrode layers 40B are provided and one layer of the ceramic green sheet for lamination 101 on which the electrically conductive pattern 102 is not printed is provided, but the number of the second dummy electrode layers 40B provided is not limited to two, and may be one or three or more. In addition, the number of the ceramic green sheets for lamination 101 on which the electrically conductive pattern 102 is not printed is not limited to one, and may be plural.

The plurality of laminated material sheets 103 and the ceramic green sheets for lamination 101 are isostatically pressed to form the mother block 110 shown in FIG. 7B.

Next, the mother block 110 is cut along a cutting line x and a cutting line y intersecting the cutting line x shown in FIG. 7B to manufacture a plurality of multilayer bodies 10 shown in FIG. 7C.

According to the above steps, the outer layer portions TG and the side margin portions WG can be made simultaneously with the formation of the multilayer body 10, but the multilayer body 10 may be made by initially forming the inner layer portion 11 in which the end portion of each of the internal electrode layers 30 in the width direction W is exposed on both lateral surfaces by cutting out from the mother block member, and then attaching the side margin portions WG to both lateral surfaces of the inner layer portion 11 so as to cover the exposed end portion of each of the internal electrode layers 30. At this time, a dielectric ceramic material similar to that of the dielectric layer 20 can be used for the side margin portion WG to be attached. In addition, the side margin portions WG may be formed by applying ceramic paste to both lateral surfaces of the inner layer portion 11.

Subsequently, the base electrode layer is formed by applying an electrically conductive paste including Cu to the end surface LS of the multilayer body 10 and firing the electrically conductive paste. The base electrode layer is formed so as to be not only on the end surfaces LS on both sides of the multilayer body 10, but also extend to the main surface TS and the lateral surface WS of the multilayer body 10 so as to cover a portion of the main surface TS and a portion of the lateral surface WS adjacent to the end surface LS.

Next, a Ni plated layer and then a Sn plated layer are made on the surface of the base electrode layer to manufacture the multilayer ceramic capacitor 1 shown in FIG. 7D.

Although example embodiments of the present invention have been described above, the present invention is not limited to the example embodiments described above, and can be implemented in various configurations without departing from the gist of the present invention. Example embodiments of the present invention further include the following combinations.

<1>

A multilayer ceramic capacitor includes a multilayer body including an inner layer portion in which a plurality of dielectric layers and a plurality of internal electrode layers are laminated, and outer layer portions sandwiching the inner layer portion in a lamination direction, and external electrodes located on a surface of the multilayer body and electrically connected to the plurality of internal electrode layers. A dummy electrode layer that does not contribute to generation of capacitance is provided in a region of at least one of the outer layer portions opposed to the plurality of internal electrode layers.

<2>

In the multilayer ceramic capacitor as described in <1>, the plurality of internal electrode layers each include Ni and Sn.

<3>

In the multilayer ceramic capacitor as described in <2>, a Sn content is about 0.1 mol or more and about 10 mol or less when a total of Ni and Sn is about 100 mol.

<4>

In the multilayer ceramic capacitor as described in any one of <1> to <3>, a thickness of each of the plurality of internal electrode layers in the lamination direction is about 0.25 μm or more and about 0.6 μm or less.

<5>

In the multilayer ceramic capacitor as described in any one of <1> to <4>, the dummy electrode layer includes Ni and Sn.

<6>

In the multilayer ceramic capacitor as described in <5>, a Sn content is about 0.1 mol or more and about 10 mol or less when a total of Ni and Sn is about 100 mol.

<7>

In the multilayer ceramic capacitor as described in any one of <1> to <6>, a thickness of the dummy electrode layer in the lamination direction is about 0.25 μm or more and about 0.6 μm or less.

<8>

In the multilayer ceramic capacitor as described in any one of <1> to <7>, a thickness of each of the plurality of dielectric layers in the lamination direction is about 0.3 μm or more and about 1.1 μm or less.

<9>

In the multilayer ceramic capacitor as described in any one of <1> to <8>, a length of the multilayer body in a length direction is about 0.39 mm or more and about 3.30 mm or less, a length of the multilayer body in the lamination direction is about 0.21 mm or more and about 2.70 mm or less, and a length of the multilayer body in a width direction is about 0.21 mm or more and about 2.70 mm or less.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion in which a plurality of dielectric layers and a plurality of internal electrode layers are laminated, and outer layer portions sandwiching the inner layer portion in a lamination direction;
external electrodes located on a surface of the multilayer body and electrically connected to the plurality of internal electrode layers; and
a plurality of dummy electrode layers that do not contribute to generation of capacitance and are located in a region of at least one of the outer layer portions opposed to the plurality of internal electrode layers.

2. The multilayer ceramic capacitor according to claim 1, wherein the plurality of internal electrode layers each include Ni and Sn.

3. The multilayer ceramic capacitor according to claim 2, wherein a Sn content is about 0.1 mol or more and about 10 mol or less when a total of Ni and Sn is about 100 mol.

4. The multilayer ceramic capacitor according to claim 2, wherein a thickness of each of the plurality of internal electrode layers in the lamination direction is about 0.25 μm or more and about 0.6 μm or less.

5. The multilayer ceramic capacitor according to claim 1, wherein the plurality of dummy electrode layers each include Ni and Sn.

6. The multilayer ceramic capacitor according to claim 5, wherein a Sn content is about 0.1 mol or more and about 10 mol or less when a total of Ni and Sn is about 100 mol.

7. The multilayer ceramic capacitor according to claim 5, wherein a thickness of each of the plurality of dummy electrode layers in the lamination direction is about 0.25 μm or more and about 0.6 μm or less.

8. The multilayer ceramic capacitor according to claim 2, wherein the plurality of dummy electrode layers each include Ni and Sn.

9. The multilayer ceramic capacitor according to claim 8, wherein a Sn content is about 0.1 mol or more and about 10 mol or less when a total of Ni and Sn is about 100 mol.

10. The multilayer ceramic capacitor according to claim 8, wherein a thickness of each of the plurality of dummy electrode layers in the lamination direction is about 0.25 μm or more and about 0.6 μm or less.

11. The multilayer ceramic capacitor according to claim 3, wherein the plurality of dummy electrode layers each include Ni and Sn.

12. The multilayer ceramic capacitor according to claim 11, wherein a Sn content is about 0.1 mol or more and about 10 mol or less when a total of Ni and Sn is about 100 mol.

13. The multilayer ceramic capacitor according to claim 11, wherein a thickness of each of the plurality of dummy electrode layers in the lamination direction is about 0.25 μm or more and about 0.6 μm or less.

14. The multilayer ceramic capacitor according to claim 4, wherein the plurality of dummy electrode layers each include Ni and Sn.

15. The multilayer ceramic capacitor according to claim 14, wherein a Sn content is about 0.1 mol or more and about 10 mol or less when a total of Ni and Sn is about 100 mol.

16. The multilayer ceramic capacitor according to claim 14, wherein a thickness of each of the plurality of dummy electrode layers in the lamination direction is about 0.25 μm or more and about 0.6 μm or less.

17. The multilayer ceramic capacitor according to claim 3, wherein a thickness of each of the plurality of internal electrode layers in the lamination direction is about 0.25 μm or more and about 0.6 μm or less.

18. The multilayer ceramic capacitor according to claim 6, wherein a thickness of each of the plurality of dummy electrode layers in the lamination direction is about 0.25 μm or more and about 0.6 μm or less.
